(19) United States
(12) Patent Application Publication
(10) Pub. No.: US 2026/0163014 A1
(43) Pub. Date: Jun. 11, 2026

(54) NON-SOLVENT ELECTRODE FOR A SECONDARY BATTERY, METHOD FOR MANUFACTURING THE SAME, AND SECONDARY BATTERY INCLUDING THE SAME

(71) Applicant: UIF (University Industry Foundation), Yonsei University, Seoul (KR)

(72) Inventors: Sang Young LEE, Seoul (KR); Jeonghun KIM, Seoul (KR); Nag Young KIM, Seoul (KR); Minseok JEONG, Seoul (KR); Heeji JEON, Seoul (KR)

(73) Assignee: UIF (University Industry Foundation), Yonsei University, Seoul (KR)

(21) Appl. No.: 19/409,894

(22) Filed: Dec. 5, 2025

(30) Foreign Application Priority Data
Dec. 6, 2024 (KR) 10-2024-0180759

(51) Int. Cl. H01M 4/66; H01M 4/04

(52) U.S. Cl. CPC H01M 4/668; H01M 4/0435; H01M 4/661; H01M 4/667

(57) ABSTRACT

The non-solvent electrode for a secondary battery of the present invention has the advantage of having strong adhesion between the current collector and the non-solvent electrode layer while having excellent electron conductivity by forming a conductive polymer film between the current collector and the non-solvent electrode layer, and has the advantage of reducing the interfacial resistance between the current collector and the non-solvent electrode layer to improve battery performance and realize a secondary battery having high energy density and long cycle life characteristics.

### CROSS-REFERENCE TO RELATED APPLICATIONS

This application claims priority to Korean Patent Application No. 10-2024-0180759, filed on Dec. 6, 2024, and all the benefits accruing therefrom under 35 U.S.C. § 119, the contents of which in its entirety are herein incorporated by reference.

### BACKGROUND

### 1. Field

The present invention relates to a non-solvent electrode for a secondary battery, a method for manufacturing the same, and a secondary battery including the same.

### 2. Description of Related Art

Lithium-ion secondary batteries are used in various application fields such as portable electronic devices, large electric vehicles, and energy storage devices. The most important factors for the application of batteries to various products are performance, such as energy density, and price. In particular, research on high-voltage, high-capacity active materials has been mainly conducted to improve energy density, but the current situation is that limits have been reached.

Accordingly, the manufacture of thick film electrodes is receiving attention. By applying thick film electrodes to a battery, it is possible to not only improve energy density but also reduce the consumption of accessories such as current collectors and minimize cell configuration, thereby expecting a cost reduction effect.

However, the conventional wet electrode manufacturing process consists of coating a current collector with a slurry in which an active material, a conductive agent, and a binder are dispersed in a process solvent, and then drying it. In particular, NMP, which is an organic solvent, plays an important role in ensuring that electrode materials are uniformly dispersed, but due to its high polarity, it has a boiling point of 202° C., requiring a lot of energy in the drying process. Furthermore, since NMP is a toxic substance, an additional recovery process is required, and as a result, a significant portion of the energy consumption during the wet electrode manufacturing process is attributable to the drying and recovery processes.

In addition to the energy efficiency aspect, during the drying of the process solvent, a phenomenon occurs where the relatively low-density conductive agent and binder float to the top due to capillary forces, resulting in a concentration gradient of non-active materials in the thickness direction. In the upper part of the electrode, the binder and conductive agent are aggregated, inhibiting ion migration and deteriorating electrochemical performance, and in the lower part of the electrode, the absolute amount of binder is insufficient, reducing the adhesion ability between the current collector and the electrode layer, which may cause peeling and cracking of the electrode layer. This phenomenon is further exacerbated when manufacturing thick film electrodes, posing a problem that limits the fabrication of high-energy density electrodes using a wet process.

To overcome this, research on dry electrodes has recently been actively underway. PTFE binders are mainly used in dry electrodes. PTFE binders have the characteristic of being fibrillated when shear force is applied, binding the conductive agent and the active material together to maintain the electrode.

However, due to its non-polar properties, the PTFE binder has an adhesive force resulting from weak van der Waals forces, and has low adhesion characteristics compared to binder materials that interact through hydrogen bonding. This hinders smooth electron migration between the electrode and the current collector, increasing interfacial resistance and resistance within the electrode, leading to degradation of the rate characteristics and cycle life characteristics of the battery. Attempts have been made to maintain adhesion and electron conductivity by dispersing carbon materials and polymer mixtures in a solution state to overcome this, but such technology requires more process time and cost, and has the disadvantage of being difficult to coat uniformly.

### REFERENCES

1. Korean Laid-Open Patent Publication No. 2024-0106552

### SUMMARY

To solve the problems described above, an object of the present invention is to provide a non-solvent electrode for a secondary battery, which has improved adhesion between a current collector and a non-solvent electrode layer and reduced interfacial resistance by forming a conductive polymer film between the current collector and the non-solvent electrode layer.

Another object of the present invention is to provide a secondary battery having high energy density and long cycle life characteristics, including the non-solvent electrode of the present invention.

Another object of the present invention is to provide a device including the secondary battery of the present invention.

Another object of the present invention is to provide a method for manufacturing a non-solvent electrode for a secondary battery.

The present invention provides a non-solvent electrode for a secondary battery, including: a current collector; a conductive polymer film coated on the current collector; and a non-solvent electrode layer formed on the conductive polymer film, wherein the conductive polymer film is a branched copolymer in which a conductive polymer side chain is copolymerized to a side branch of a functional polymer main chain including a functional group.

The present invention also provides a secondary battery including the non-solvent electrode of the present invention.

The present invention also provides a device including the secondary battery of the present invention, wherein the device is any one selected from a communication device, a transportation device, and an energy storage device.

The present invention also provides a method for manufacturing a non-solvent electrode for a secondary battery, including the steps of: manufacturing a branched copolymer in which a conductive polymer side chain is copolymerized to a side branch of a functional polymer main chain including a functional group; coating the branched copolymer on one surface of a current collector to form a conductive polymer film; manufacturing a non-solvent electrode sheet by sheeting a non-solvent electrode mixture including an electrode active material, a conductive agent, and a binder into a sheet form; and attaching the non-solvent electrode sheet onto the conductive polymer film and then press-compaction to form a non-solvent electrode layer.

The non-solvent electrode for a secondary battery of the present invention has the advantage of having strong adhesion between the current collector and the non-solvent electrode layer while having excellent electron conductivity by forming a conductive polymer film between the current collector and the non-solvent electrode layer, and has the advantage of reducing the interfacial resistance between the current collector and the non-solvent electrode layer to improve battery performance and realize a secondary battery having high energy density and long cycle life characteristics.

The effects of the present invention are not limited to the effects mentioned above. It should be understood that the effects of the present invention include all effects that can be inferred from the description below.

### BRIEF DESCRIPTION OF THE DRAWINGS

FIG. 1 is a schematic diagram comparing a non-solvent electrode (dry electrode) including a current collector on which a conductive polymer film is formed according to the present invention and a non-solvent electrode (dry electrode) including a current collector that does not include a conductive polymer film.

FIG. 2 is a photograph showing the synthesis process of the branched copolymer manufactured in example 1 according to the present invention.

FIG. 3 is a photograph showing the process of coating a conductive polymer film on an aluminum current collector of example 1 according to the present invention.

FIG. 4 is a cross-sectional SEM photograph of the non-solvent electrode manufactured in example 1 and comparative example 1 according to the present invention.

FIG. 5 is a graph (a) showing the adhesion performance results and a photograph (b) of the electrode of the non-solvent electrode manufactured in example 1 and comparative example 1 according to the present invention.

FIG. 6 is a graph showing the results of interfacial resistance analysis of the non-solvent electrode manufactured in example 1 and comparative example 1 according to the present invention.

FIG. 7 is a graph showing the comparison results of the resistance within the electrode using the galvanostatic intermittent titration technique of the non-solvent electrode manufactured in example 1 and comparative example 1 according to the present invention.

FIG. 8 is a graph showing the charge/discharge performance results for a half-cell using the non-solvent electrode manufactured in example 1 and comparative example 1 according to the present invention.

FIG. 9 is a graph comparing the rate capability (capacity retention rate) characteristics according to various current densities for a half-cell using the non-solvent electrode manufactured in example 1 and comparative example 1 according to the present invention.

FIG. 10 is a graph comparing the cycle life characteristics for a half-cell using the non-solvent electrode manufactured in example 1 and comparative example 1 according to the present invention.

### DETAILED DESCRIPTION

Hereinafter, the present invention will be described in more detail with one example.

The present invention relates to a non-solvent electrode for a secondary battery, a method for manufacturing the same, and a secondary battery including the same.

As described above, the PTFE binder mainly used in dry electrodes has an adhesive force resulting from weak van der Waals forces due to its non-polar properties, and has low adhesion characteristics compared to binder materials that interact through hydrogen bonding. Due to these characteristics, smooth electron migration between the electrode and the current collector is hindered, increasing interfacial resistance and resistance within the electrode, which has become a cause of degradation of the rate characteristics and cycle life characteristics of the battery. Attempts have been made to maintain adhesion and electron conductivity by dispersing carbon materials and polymer mixtures in a solution state to overcome this, but such technology requires more process time and cost, and has the disadvantage of being difficult to coat uniformly.

Accordingly, in the present invention, by forming a conductive polymer film between the current collector and the non-solvent electrode layer, there is an advantage of having strong adhesion between the current collector and the non-solvent electrode layer while having excellent electron conductivity. Furthermore, it is possible to reduce the interfacial resistance between the current collector and the non-solvent electrode layer, thereby improving battery performance and realizing a secondary battery having high energy density and long cycle life characteristics.

Specifically, the present invention provides a non-solvent electrode for a secondary battery, including: a current collector; a conductive polymer film coated on the current collector; and a non-solvent electrode layer formed on the conductive polymer film, wherein the conductive polymer film is a branched copolymer in which a conductive polymer side chain is copolymerized to a side branch of a functional polymer main chain including a functional group.

The current collector may be at least one selected from the group consisting of aluminum (Al), nickel (Ni), silver (Ag), gold (Au), palladium (Pd), platinum (Pt), titanium (Ti), tantalum (Ta), copper (Cu), chromium (Cr), molybdenum (Mo), and zinc (Zn), preferably at least one selected from the group consisting of aluminum (Al), nickel (Ni), and copper (Cu), and most preferably aluminum (Al).

The conductive polymer film may be a branched copolymer in which a conductive polymer side chain is copolymerized to a side branch of a functional polymer main chain including a functional group. Generally, a conductive polymer is a light material capable of electron conduction and is a material that can improve electrode and battery performance, but when such a conductive polymer is used alone, the adhesive force may be significantly low because there is no functional group capable of chemical bonding with the current collector and the non-solvent electrode layer. In the present invention, to improve this, by forming a conductive polymer film using a branched copolymer in which a conductive polymer side chain is copolymerized to a side branch of a functional polymer main chain including a functional group that can improve adhesion, the adhesion between the current collector and the non-solvent electrode layer is significantly increased, the interfacial resistance is reduced, and the output and cycle life characteristics of the battery can be greatly improved.

The functional polymer may be a poly(styrene sulfonic acid-co-maleic acid) (P(SSA-MA)) copolymer formed by copolymerizing vinylstyrenesulfonate and maleic acid.

The functional polymer includes a functional group such as a carboxylic acid group, and thus can chemically bond with the current collector of the non-solvent electrode layer to exhibit high adhesive performance.

The conductive polymer may be at least one selected from the group consisting of a polythiophene-based polymer, a polyaniline-based polymer, a polypyrrole-based polymer, a polyacetyl-based polymer, a polyazine-based polymer, a polyphenylene-based polymer, and a polyselenophene-based polymer, preferably a polythiophene-based polymer or a polyaniline-based polymer, and most preferably a polythiophene-based polymer.

The polythiophene-based polymer may be obtained from 3,4-ethylenedioxythiophene (EDOT).

The branched copolymer may consist of the following Chemical Formula 1.

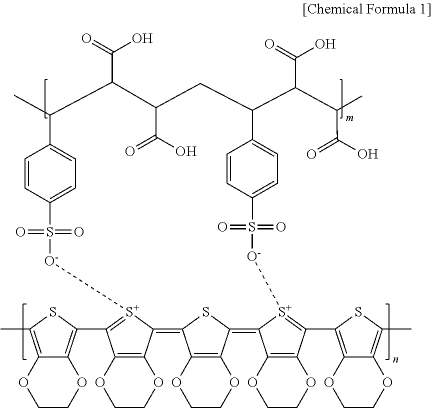

In Chemical Formula 1, m and n are polymerization mole ratios of each repeating unit, where m is 0.5 to 1.8, n is 0.5 to 1.8, and min is 0.5 to 1.8:0.5 to 1.8.

Preferably, in Chemical Formula 1, m may be 0.5 to 1.4, and n may be 0.5 to 1.4, and most preferably, m may be 0.5 to 1.0, and n may be 0.5 to 1.0. Further, min may be 0.5 to 1.8:0.5 to 1.8, preferably 0.5 to 1.4:0.5 to 1.4, and most preferably 0.5 to 1:0.5 to 1. Specifically, if n is less than 0.5, adhesion may decrease, and conversely, if it exceeds 1.8, conductivity may decrease.

The conductive polymer film may be one in which the functional polymer and the conductive polymer are copolymerized at a weight ratio of 1:1 to 1:7.5, preferably 1:3 to 1:7.5, more preferably 1:5 to 1:7.5, and most preferably 1:7.5. Specifically, if the functional polymer is less than 1 part by weight, adhesion may increase, and conversely, if it exceeds 1.8 parts by weight, conductivity may increase.

The conductive polymer film may form a thin and uniform coating layer on the current collector, wherein the thickness of the conductive polymer film may be 1 nm to 3 μm, preferably 10 nm to 1 μm, and most preferably 50 to 100 nm. In this case, if the thickness of the conductive polymer film is less than 1 nm, the migration of electrons is difficult, and electron conductivity may be significantly lowered, and if it exceeds 3 μm, adhesion to the current collector is excellent, but resistance increases, and battery performance may be degraded.

The current collector on which the conductive polymer film is formed has strong adhesion to the non-solvent electrode layer and may have lower interfacial resistance through electrochemical analysis including a liquid electrolyte. Additionally, there is an advantage that the internal resistance of the electrode is lower than that of a general current collector. Furthermore, when the current collector on which the conductive polymer film is formed is applied as a secondary battery, significantly superior rate capability and cycle life characteristics compared to a general current collector can be secured.

The non-solvent electrode layer may be laminated by press-compaction of a non-solvent electrode mixture including an electrode active material, a conductive agent, and a binder without including a solvent.

The electrode active material may be a positive active material or a negative active material.

The positive active material may be at least one selected from the group consisting of LiCoO₂, LiNiO₂, LiMn₂O₄, LiCoPO₄, LiFePO₄, LiNi_{1/3}Mn_{1/3}Co_{1/3}O₂ and LiNi_{1-x-y-z}CoₓM1_{y}M2₂O₂ (M1 and M2 are each independently any one of Al, Ni, Co, Fe, Mn, V, Cr, Ti, W, Ta, Mg, or Mo, and x, y, and z are each independently atomic fractions of oxide composition elements, where 0≤x<0.5, 0≤y<0.5, 0≤z<0.5, and 0<x+y+z≤1), and preferably LiNi_{1-x-y-z}CoₓM1_{y}M2₂O₂.

The negative active material may be at least one selected from the group consisting of a carbonaceous material of natural graphite or artificial graphite; a metal (Me) that is lithium-containing titanium composite oxide (LTO), Si, Sn, Li, Zn, Mg, Cd, Ce, Ni, or Fe; an alloy consisting of the metal (Me); an oxide (MeOx) of the metal (Me); and a composite of the metal (Me) and carbon; and preferably artificial graphite.

The conductive agent may be at least one selected from the group consisting of carbon fiber, carbon black, acetylene black, Ketjen black, graphene, multi-wall carbon nanotube (MWCNT, Multi Wall Carbon Nano Tube), double-wall carbon nanotube (DWCNT, Double Wall Carbon Nano Tube), and single-wall carbon nanotube (SWCNT, Single Wall Carbon Nano Tube), and preferably carbon black.

The binder may be at least one selected from the group consisting of polytetrafluoroethylene, polyvinylidene fluoride, polyvinylidene fluoride-hexafluoropropylene, polyvinylidene fluoride-trichloroethylene, polymethylmethacrylate, polyacrylonitrile, polyvinylpyrrolidone, polyvinylacetate, ethylene vinyl acetate copolymer, polyethylene oxide, cellulose acetate, cellulose acetate butyrate, cellulose acetate propionate, cyanoethylpullulan, cyanoethylpolyvinyl alcohol, cyanoethylcellulose, cyanoethylsucrose, pullulan, and carboxymethylcellulose, preferably at least one selected from the group consisting of polytetrafluoroethylene, polyvinylidene fluoride, and polymethylmethacrylate, and most preferably polytetrafluoroethylene.

Preferably, specifically, although not explicitly described in the examples or comparative examples below, the non-solvent electrode according to the present invention was manufactured by varying the following three conditions, applied to a lithium secondary battery, and charged and discharged by a conventional method to evaluate the cycle life of the current collector, dust generation of the electrode, and internal resistance of the electrode.

As a result, unlike other conditions and other numerical ranges, when all of the conditions below were satisfied, the conductive polymer film formed on the current collector protected the current collector, unlike conventional lithium secondary batteries, greatly improving the cycle life of the current collector, and no dust was generated from the electrode during the manufacturing process. Furthermore, due to the strong adhesion between the current collector and the non-solvent electrode layer, almost no internal resistance of the electrode occurred, resulting in excellent battery performance.

1 The branched copolymer consists of the following Chemical Formula 1, 2) the conductive polymer film has a thickness of 50 nm to 100 nm, and (3) the non-solvent electrode layer may be laminated by press-compaction of a non-solvent electrode mixture including an electrode active material, a conductive agent, and a binder.

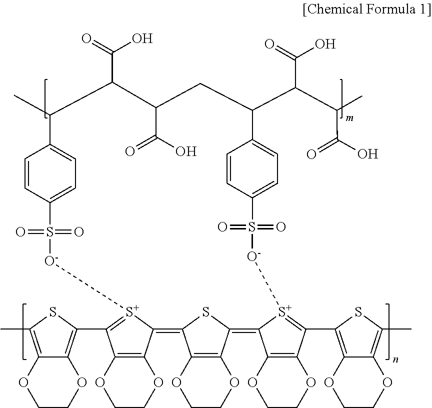

In Chemical Formula 1, m and n are polymerization mole ratios of each repeating unit, where m is 0.5 to 1.0, n is 0.5 to 1.0, and min is 0.5 to 1:0.5 to 1.

However, if even one of the three conditions was not satisfied, electrode dust occurred during the manufacturing process, and peeling of the non-solvent electrode layer and dust generation caused scratches on the surface, significantly degrading the cycle life of the current collector, and the internal resistance of the electrode increased, resulting in significantly poor battery performance.

Further, the present invention provides a secondary battery including the non-solvent electrode of the present invention.

Further, the present invention provides a device including the secondary battery of the present invention, wherein the device is any one selected from a communication device, a transportation device, and an energy storage device.

Further, the present invention provides a method for manufacturing a non-solvent electrode for a secondary battery, including the steps of: manufacturing a branched copolymer in which a conductive polymer side chain is copolymerized to a side branch of a functional polymer main chain including a functional group; coating the branched copolymer on one surface of a current collector to form a conductive polymer film; manufacturing a non-solvent electrode sheet by sheeting a non-solvent electrode mixture including an electrode active material, a conductive agent, and a binder into a sheet form; and attaching the non-solvent electrode sheet onto the conductive polymer film and then press-compaction to form a non-solvent electrode layer.

The step of forming the conductive polymer film may be coated by bar coating or spin coating method at a temperature of 10 to 60° C. for 1 second to 1 hour, preferably 5 minutes to 1 hour. In this case, if any one of the coating temperature and coating time does not satisfy the range, the conductive polymer film may not be properly formed on the current collector or may be formed with a non-uniform thickness, thereby reducing the adhesion between the current collector and the non-solvent electrode layer.

The step of manufacturing the non-solvent electrode sheet may involve manufacturing the non-solvent electrode sheet by mixing and roll pressing method at a temperature of 10 to 80° C. for 20 minutes to 1 hour.

The step of forming the non-solvent electrode layer may involve forming the non-solvent electrode layer using a press compaction method at a temperature of 10 to 180° C. for 1 second to 2 hours. In this case, if any one of the compaction temperature and compaction time does not satisfy the range, a phenomenon may occur where the non-solvent electrode sheet does not adhere to the conductive polymer film or partially peels off.

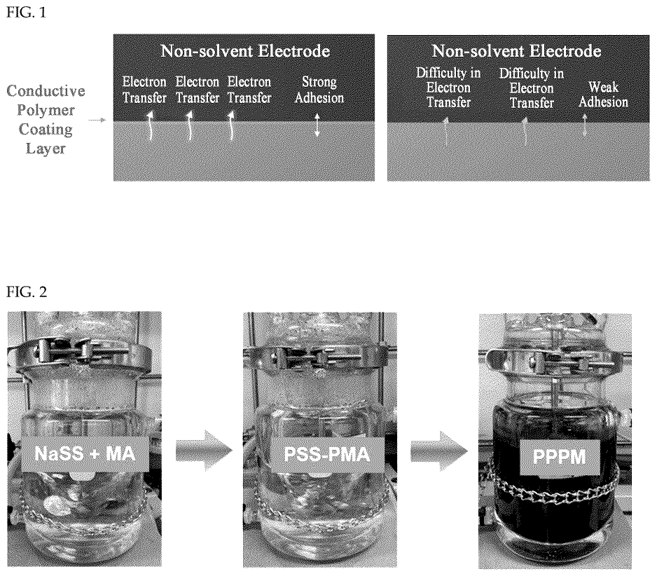

FIG. 1 is a schematic diagram comparing a non-solvent electrode (dry electrode) including a current collector on which a conductive polymer film is formed according to the present invention and a non-solvent electrode (dry electrode) including a current collector that does not include a conductive polymer film.

Referring to FIG. 1, in the case of the non-solvent electrode including the current collector on which the conductive polymer film is formed, the strong adhesion between the current collector on which the conductive polymer film is formed and the non-solvent electrode layer showed very excellent smooth electron migration from the current collector. On the other hand, in the case of the non-solvent electrode including the current collector that does not include the conductive polymer film, weak adhesion between the current collector and the non-solvent electrode layer indicated difficulty in electron migration.

Hereinafter, the present invention will be described in more detail based on examples, but the present invention is not limited by the following examples.

### EXAMPLES

### Example 1: Manufacture of Non-Solvent Electrode (Current Collector Coated with a Conductive Polymer Film)

### (1) Manufacture of Branched Copolymer

As shown in the following Reaction Scheme 1, vinyl styrene sulfonate and maleic acid were mixed at a molar ratio of 1:1 and then radically copolymerized at a temperature of 80° C. for 12 hours to prepare a P(SSA-co-MA) copolymer. Subsequently, the P(SSA-co-MA) copolymer and 3,4-ethylenedioxythiophene (EDOT) were mixed at a weight ratio of 1:7.5 to prepare a branched copolymer, a PEDOT:P(SSA-co-MA)(PPPM) copolymer.

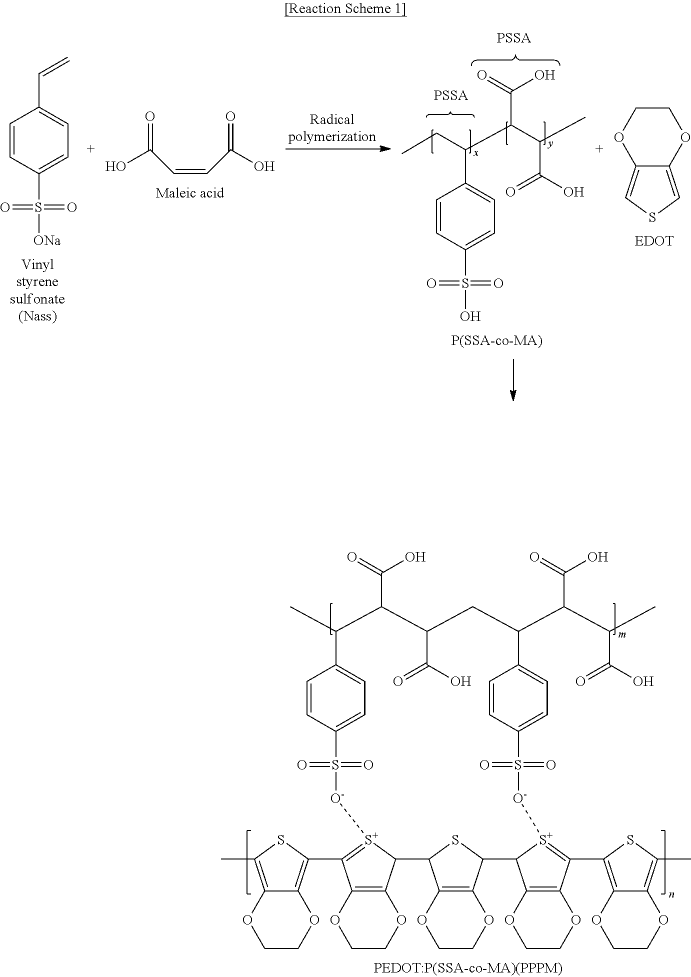

FIG. 2 is a photograph showing the synthesis process of the branched copolymer manufactured in example 1. Referring to FIG. 2, poly(styrene sulfonic acid-co-maleic acid) (P(SSA-MA)) was synthesized by copolymerizing vinylstyrenesulfonate and maleic acid, and then 3,4-ethylenedioxythiophene (EDOT), which is a conductive polymer, was mixed to synthesize a PEDOT:P(SSA-co-MA)(PPPM) copolymer.

(2) Manufacture of Non-Solvent Electrode Including Current Collector Coated with a Conductive Polymer Film

The PEDOT:P(SSA-co-MA) (PPPM) copolymer was bar coated on an aluminum current collector at a temperature of 25° C. for 10 minutes to prepare a current collector on which a conductive polymer film having a thickness of 100 nanometers was formed.

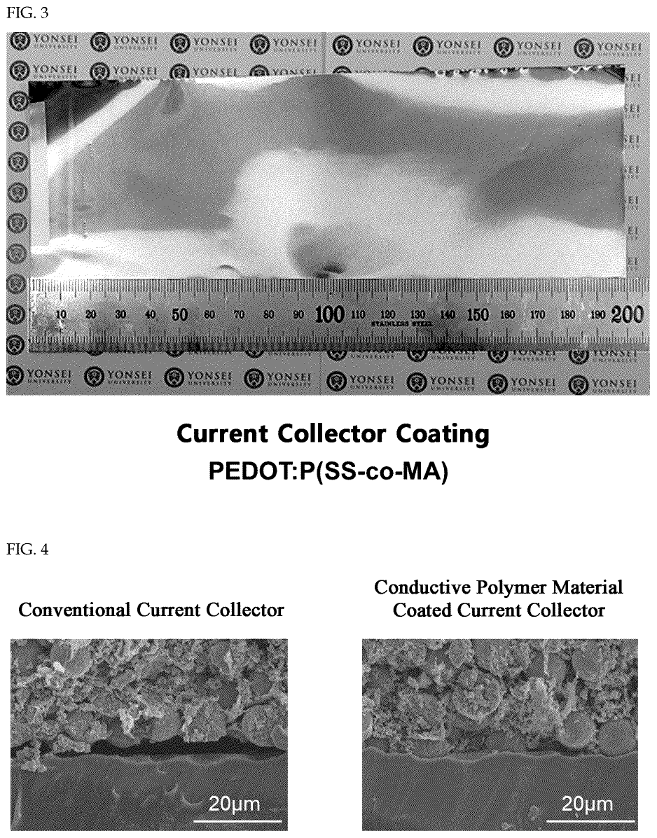

FIG. 3 is a photograph showing the process of coating a conductive polymer film on the aluminum current collector of example 1.

Further, a non-solvent electrode mixture was prepared by mixing NMC811 as the electrode active material, carbon black as the conductive agent, and polytetrafluoroethylene (PTFE) as the binder at a weight ratio of 96:2:2, and then a sheet-form non-solvent electrode sheet was manufactured using this by mixing and roll pressing method at a temperature of 25° C. for 1 hour. Subsequently, the non-solvent electrode sheet was laminated on the conductive polymer film and then press-compaction was performed using a roll press equipment at a temperature of 120° C. for 30 minutes to manufacture a non-solvent electrode.

### Comparative Example 1: Manufacture of Non-Solvent Electrode (Current Collector not Coated with a Conductive Polymer Film)

A non-solvent electrode was manufactured in the same manner as example 1, except that a conductive polymer film was not formed on the aluminum current collector.

### Comparative Example 2: Manufacture of Non-Solvent Electrode (Current Collector Coated with a Conductive Polymer Film Using PEDOT:PSS Copolymer)

A non-solvent electrode was manufactured in the same manner as example 1, except that a PEDOT:PSS copolymer was coated instead of the PEDOT:P(SSA-co-MA) (PPPM) copolymer on the aluminum current collector to form a conductive polymer film.

### Comparative Example 3: Manufacture of Non-Solvent Electrode (Mixing PEDOT:P(SSA-co-MA) (PPPM) Copolymer with Non-Solvent Electrode Mixture)

The branched copolymer of example 1 was mixed with a non-solvent electrode mixture in which NMC811 as the electrode active material, carbon black as the conductive agent, and polytetrafluoroethylene (PTFE) as the binder were mixed at a weight ratio of 96:2:2. Subsequently, a non-solvent electrode sheet was manufactured in the same manner as example 1, and then the non-solvent electrode sheet was laminated on an aluminum current collector and press-compaction was performed using a roll press equipment at a temperature of 120° C. for 1 hour to manufacture a non-solvent electrode.

### Experimental Example 1: SEM Analysis

SEM analysis was performed on the non-solvent electrodes manufactured in example 1 and comparative example 1 to confirm the interface between the current collector and the non-solvent electrode layer, and the results are shown in FIG. 4.

FIG. 4 is a cross-sectional SEM photograph of the non-solvent electrodes manufactured in example 1 and comparative example 1. Referring to FIG. 4, in the case of example 1, the adhesion between the current collector and the non-solvent electrode layer was excellent, resulting in a stable state where they were tightly bonded without gaps, whereas in the case of comparative example 1, it was confirmed that a large gap existed between the current collector and the non-solvent electrode layer, and the adhesion was very weak, forming an unstable interface.

### Experimental Example 2: Adhesion Test Analysis

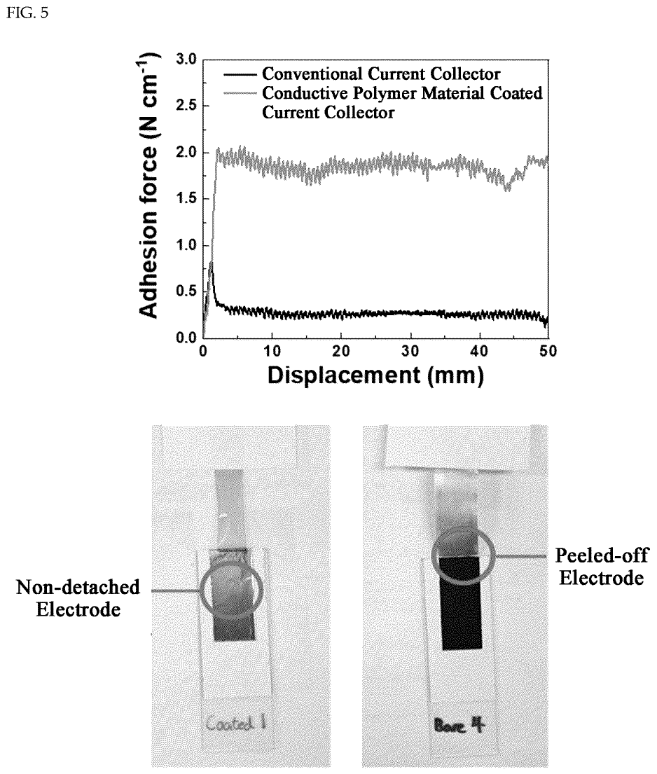

Adhesion test analysis was performed on the non-solvent electrodes manufactured in example 1 and comparative example 1 to confirm adhesion, and the results are shown in FIG. 5.

The adhesion test analysis was performed using the 180° adhesion strength method utilizing a universal testing machine.

FIG. 5 is a graph (a) showing the adhesion performance results and a photograph (b) of the electrode of the non-solvent electrodes manufactured in example 1 and comparative example 1. Referring to FIG. 5, in the case of example 1, the adhesion was about 1.75 to 2 N/cm2, and the electrode was well maintained without peeling, whereas in the case of comparative example 1, the adhesion was 0.5 N/cm2, and it was confirmed that the electrode peeled off due to poor adhesion.

### Experimental Example 3: Interfacial Resistance and Galvanostatic Resistance Analysis

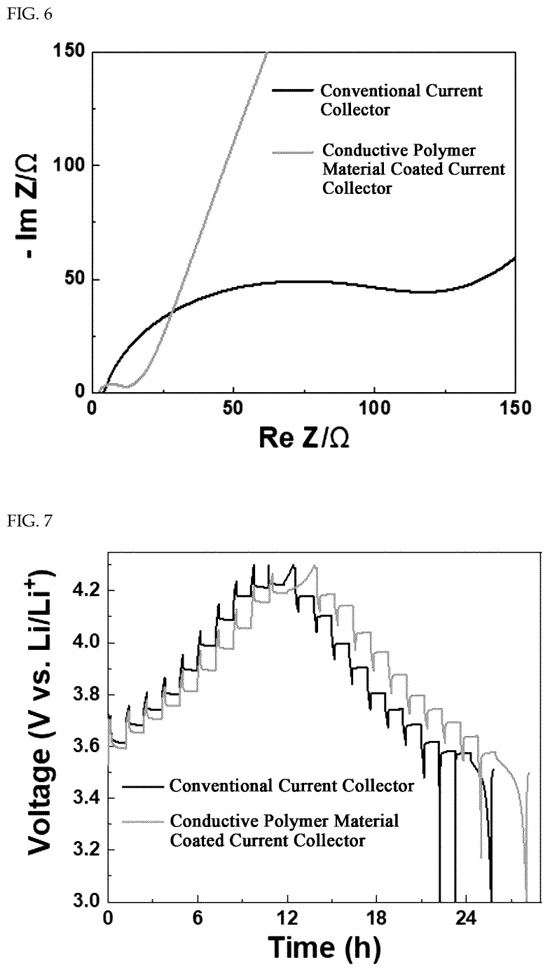

To confirm the interfacial resistance of the non-solvent electrodes manufactured in example 1 and comparative example 1, a symmetric cell including an electrolyte was manufactured by a conventional method, and interfacial resistance analysis and resistance analysis within the electrode using the galvanostatic intermittent titration technique were performed, and the results are shown in FIGS. 6 and 7.

The symmetric cell was manufactured consisting of a non-solvent electrode and a separator of the same weight and thickness, and the interfacial resistance test and resistance analysis using the galvanostatic intermittent titration technique were performed, respectively, by electrochemical impedance spectroscopy and a repetitive method of current application time at a 0.33 charge/discharge rate and a relaxation time of 1 hour.

FIG. 6 is a graph showing the results of interfacial resistance analysis of the non-solvent electrodes manufactured in example 1 and comparative example 1. Referring to FIG. 6, in the case of example 1, due to the strong adhesion of the conductive polymer film coated on the current collector, almost no interfacial resistance occurred between the current collector and the non-solvent electrode layer. On the other hand, in the case of comparative example 1, the interfacial resistance between the current collector and the non-solvent electrode layer was found to be very high, confirming that the realization of battery performance was impossible.

FIG. 7 is a graph showing the comparison results of the resistance within the electrode using the galvanostatic intermittent titration technique of the non-solvent electrodes manufactured in example 1 and comparative example 1. Referring to FIG. 7, it was confirmed that example 1 showed relatively lower electrode resistance compared to comparative example 1.

### Experimental Example 4: Charge/Discharge Performance Analysis

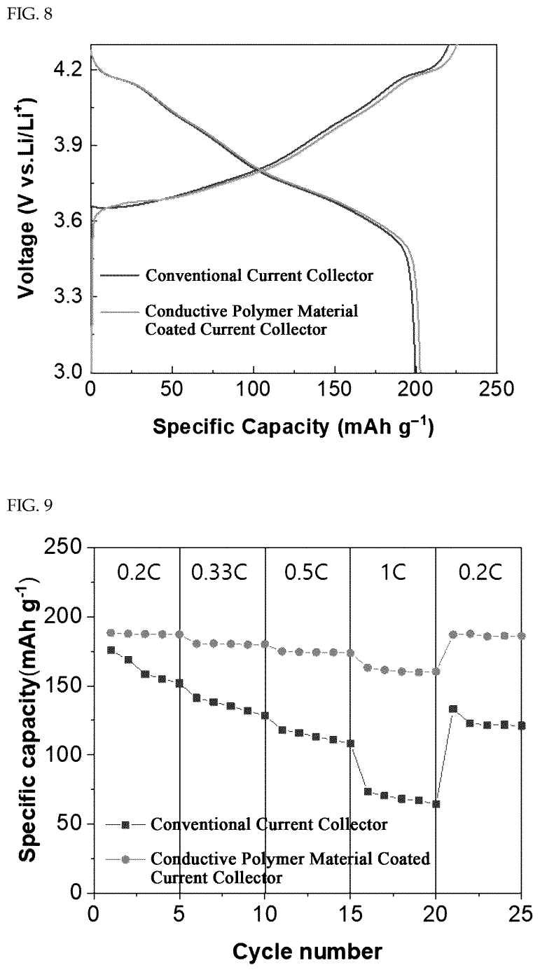

To confirm the charge/discharge performance of the non-solvent electrodes manufactured in example 1 and comparative example 1, a half-cell was manufactured by a conventional method and charge/discharge analysis was performed, and the results are shown in FIG. 8.

The half-cell was manufactured by a conventional method using 200 μm Li metal and a 20 μm thick separator placed between each electrode, and an electrolyte solution of 1M LiPF6 EC/EMC (3/7 v/v), 10 wt % FEC, and 2 wt % VC, and the charge/discharge performance was performed by a repetitive method of a 0.33 charge/discharge rate.

FIG. 8 is a graph showing the charge/discharge performance results for a half-cell using the non-solvent electrodes manufactured in example 1 and comparative example 1. Referring to FIG. 8, it was confirmed that example 1 showed a higher capacity compared to comparative example 1 due to low electrode resistance.

### Experimental Example 5: Electrochemical Performance Analysis

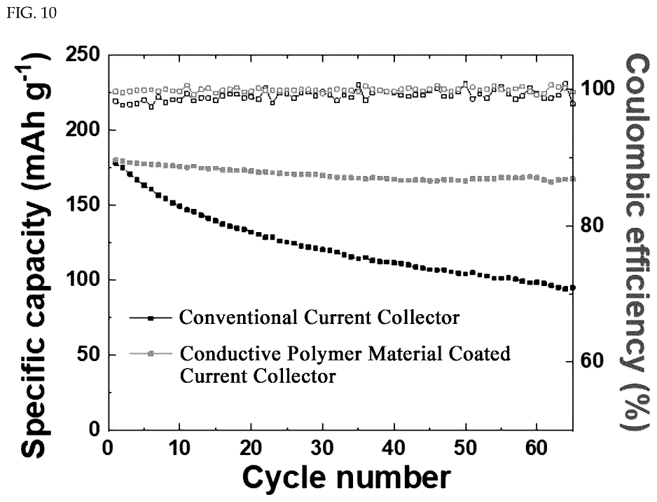

To confirm the electrochemical performance of the non-solvent electrodes manufactured in example 1 and comparative example 1, a symmetric cell including an electrolyte was manufactured by a conventional method, and rate capability characteristics and cycle life characteristics analysis were performed, and the results are shown in FIGS. 9 and 10.

FIG. 9 is a graph comparing the rate capability (capacity retention rate) characteristics according to various current densities for a half-cell using the non-solvent electrode manufactured in example 1 and comparative example 1. Referring to FIG. 9, it was confirmed that example 1 had significantly superior capacity retention rate compared to comparative example 1.

FIG. 10 is a graph comparing the cycle life characteristics for a half-cell using the non-solvent electrode manufactured in example 1 and comparative example 1. Referring to FIG. 10, in the case of example 1, by including the current collector coated with the conductive polymer film, the battery capacity remained high at 168 mAh/g even when the number of charge/discharge cycles increased, and the Coulombic efficiency also showed a high value of 99% or more, confirming excellent reversibility and electrochemical performance. On the other hand, in the case of comparative example 1, the battery capacity rapidly decreased as the number of charge/discharge cycles increased, and the Coulombic efficiency also showed a low value of 95% or less.

### Experimental Example 6: Adhesion Test, Interfacial Resistance, and Electrochemical Performance Analysis of Non-Solvent Electrode

Adhesion test, interfacial resistance, charge/discharge performance, and electrochemical performance were performed on the non-solvent electrodes manufactured in example 1 and comparative examples 1 to 3 in the same manner as Experimental Examples 2 to 5, and the results are shown in Table 1 below.

TABLE 1

| | | Comp. | Comp. | Comp. |
|---|---|---|---|---|
| Classification | Ex. 1 | Ex. 1 | Ex. 2 | Ex. 3 |
| Adhesion (N/cm) | 1.81 | 0.28 | 1.1 | 1.8 |
| Interfacial resistance (Ω) | 10 | 120 | 80 | 130 |
| Discharge capacity (mAh/g) | 203 | 200 | 198 | 180 |
| Cycle life characteristics after 60 | 168 | 98 | 140 | 110 |
| cycles (mAh/g) | | | | |
| Coulombic efficiency after 60 | 99 | 95 | 95 | 92 |
| cycles (%) | | | | |

According to the results in Table 1, it was confirmed that example 1 had significantly superior adhesion between the current collector and the non-solvent electrode layer compared to comparative examples 1 to 3, and the interfacial resistance was the lowest. Furthermore, it was found that excellent values were shown in discharge capacity, cycle life characteristics, and Coulombic efficiency, all due to high energy density.

On the other hand, in the case of comparative example 1, the adhesion between the current collector and the non-solvent electrode layer was very low, the interfacial resistance showed the highest value, and the electrochemical performance in terms of discharge capacity, cycle life characteristics, and Coulombic efficiency was generally low and did not meet expectations.

Furthermore, in the case of comparative examples 2 and 3, it was confirmed that if the functional polymer was not copolymerized or if the branched copolymer was mixed with the non-solvent electrode layer, the adhesion between the current collector and the non-solvent electrode layer was very poor, or very low electrochemical performance was shown due to high resistance.

What is claimed is:

1. A non-solvent electrode for a secondary battery, comprising:
a current collector;
a conductive polymer film coated on the current collector; and
a non-solvent electrode layer formed on the conductive polymer film,
wherein the conductive polymer film is a branched copolymer in which a conductive polymer side chain is copolymerized to a side branch of a functional polymer main chain including a functional group.

2. The non-solvent electrode for a secondary battery according to claim 1, wherein the current collector is at least one selected from the group consisting of aluminum (Al), nickel (Ni), silver (Ag), gold (Au), palladium (Pd), platinum (Pt), titanium (Ti), tantalum (Ta), copper (Cu), chromium (Cr), molybdenum (Mo), and zinc (Zn).

3. The non-solvent electrode for a secondary battery according to claim 1, wherein the functional polymer is a poly(styrene sulfonic acid-co-maleic acid) (P(SSA-MA)) copolymer formed by copolymerizing vinylstyrenesulfonate and maleic acid.

4. The non-solvent electrode for a secondary battery according to claim 1, wherein the conductive polymer is at least one selected from the group consisting of a polythiophene-based polymer, a polyaniline-based polymer, a polypyrrole-based polymer, a polyacetyl-based polymer, a polyazine-based polymer, a polyphenylene-based polymer, and a polyselenophene-based polymer.

5. The non-solvent electrode for a secondary battery according to claim 1,
wherein the branched copolymer consists of the following Chemical Formula 1, 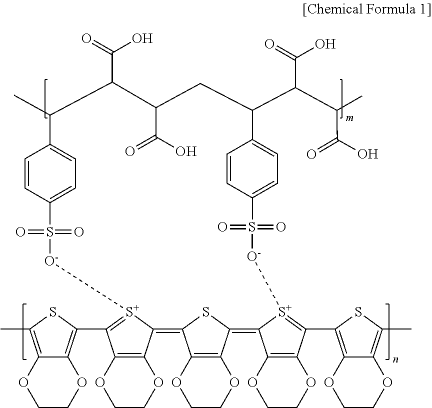
the m and the n are polymerization mole ratios of each repeating unit, where the m is 0.5 to 1.8, the n is 0.5 to 1.8, and the ratio of min is 0.5 to 1.8:0.5 to 1.8.

6. The non-solvent electrode for a secondary battery according to claim 1, wherein the conductive polymer film is one in which the functional polymer and the conductive polymer are copolymerized at a weight ratio of 1:1 to 1:7.5.

7. The non-solvent electrode for a secondary battery according to claim 1, wherein the conductive polymer film has a thickness of 1 nm to 3 μm.

8. The non-solvent electrode for a secondary battery according to claim 1, wherein the non-solvent electrode layer is laminated by press-compaction of a non-solvent electrode mixture including an electrode active material, a conductive agent, and a binder.

9. The non-solvent electrode for a secondary battery according to claim 8, wherein the electrode active material is a positive active material or a negative active material.

10. The non-solvent electrode for a secondary battery according to claim 9,
wherein the positive active material is at least one selected from the group consisting of LiCoO₂, LiNiO₂, LiMn₂O₄, LiCoPO₄, LiFePO₄, LiNi_{1/3}Mn_{1/3}C_{1/3}O₂, and LiNi_{1-x-y-z}CoₓM1_{y}M2_{z}O₂,
M1 and M2 are each independently any one of Al, Ni, Co, Fe, Mn, V, Cr, Ti, W, Ta, Mg, or Mo,
x, y, and z are each independently atomic fractions of oxide composition elements,
0≤x<0.5, 0≤y<0.5, 0≤z<0.5, and 0<x+y+z≤1.

11. The non-solvent electrode for a secondary battery according to claim 9, wherein the negative active material is at least one selected from the group consisting of a carbonaceous material of natural graphite or artificial graphite; a metal (Me) that is lithium-containing titanium composite oxide (LTO), Si, Sn, Li, Zn, Mg, Cd, Ce, Ni, or Fe; an alloy consisting of the metal (Me); an oxide (MeOₓ) of the metal (Me); and a composite of the metal (Me) and carbon.

12. The non-solvent electrode for a secondary battery according to claim 8, wherein the conductive agent is at least one selected from the group consisting of carbon fiber, carbon black, acetylene black, Ketjen black, graphene, multi-wall carbon nanotube (MWCNT, Multi Wall Carbon Nano Tube), double-wall carbon nanotube (DWCNT, Double Wall Carbon Nano Tube), and single-wall carbon nanotube (SWCNT, Single Wall Carbon Nano Tube).

13. The non-solvent electrode for a secondary battery according to claim 8, wherein the binder is at least one selected from the group consisting of polytetrafluoroethylene, polyvinylidene fluoride, polyvinylidene fluoride-hexafluoropropylene, polyvinylidene fluoride-trichloroethylene, polymethylmethacrylate, polyacrylonitrile, polyvinylpyrrolidone, polyvinylacetate, ethylene vinyl acetate copolymer, polyethylene oxide, cellulose acetate, cellulose acetate butyrate, cellulose acetate propionate, cyanoethylpullulan, cyanoethylpolyvinyl alcohol, cyanoethylcellulose, cyanoethylsucrose, pullulan, and carboxymethylcellulose.

14. The non-solvent electrode for a secondary battery according to claim 1,
wherein the branched copolymer consists of the following Chemical Formula 1,
the conductive polymer film has a thickness of 50 nm to 100 nm,
the non-solvent electrode layer is laminated by press-compaction of a non-solvent electrode mixture including an electrode active material, a conductive agent, and a binder, 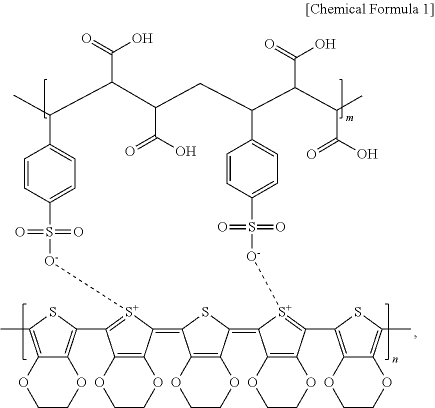
and
the m and the n are polymerization mole ratios of each repeating unit, where the m is 0.5 to 1.0, the n is 0.5 to 1.0, and the ratio of min is 0.5 to 1:0.5 to 1.

15. A secondary battery including the non-solvent electrode according to claim 1.

16. A device including the secondary battery of claim 15, wherein the device is any one selected from a communication device, a transportation device, and an energy storage device.

17. A method for manufacturing a non-solvent electrode for a secondary battery, comprising the steps of: manufacturing a branched copolymer in which a conductive polymer side chain is copolymerized to a side branch of a functional polymer main chain including a functional group; coating the branched copolymer on one surface of a current collector to form a conductive polymer film;
manufacturing a non-solvent electrode sheet by sheeting a non-solvent electrode mixture including an electrode active material, a conductive agent, and a binder into a sheet form; and
attaching the non-solvent electrode sheet onto the conductive polymer film and then press-compaction to form a non-solvent electrode layer.

18. The method for manufacturing a non-solvent electrode for a secondary battery according to claim 17, wherein the step of forming the conductive polymer film involves coating by bar coating or spin coating method at a temperature of 10 to 60° C. for 5 minutes to 1 hour.

19. The method for manufacturing a non-solvent electrode for a secondary battery according to claim 17, wherein the step of manufacturing the non-solvent electrode sheet involves manufacturing the non-solvent electrode sheet by mixing and roll pressing method at a temperature of 10 to 80° C. for 20 minutes to 1 hour.

20. The method for manufacturing a non-solvent electrode for a secondary battery according to claim 17, wherein the step of forming the non-solvent electrode layer involves forming the non-solvent electrode layer using a press compaction method at a temperature of 10 to 180° C. for 1 second to 2 hours.
